(19) United States
(12) Patent Application Publication
(10) Pub. No.: US 2009/0074490 A1
(43) Pub. Date: Mar. 19, 2009

(54) AUTOMATIC SCANNING APPARATUS

(75) Inventors: Naoki Shoji, Kanagawa-ken (JP); Seiji Iino, Kanagawa-ken (JP); Satoshi Onuma, Kanagawa-ken (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,273

(22) Filed: Sep. 9, 2008

Related U.S. Application Data
(60) Provisional application No. 60/972,478, filed on Sep. 14, 2007.

(51) Int. Cl. G03G 15/00

(52) U.S. Cl. 399/374

(57) ABSTRACT

According to an embodiment of the invention, a reverse path for double-side scanning of an original and a paper discharge path for reversing the original after completion of double-side scanning are separately provided. On completion of its double-side scanning, a preceding original is turned into the paper discharge path, reversed in the paper discharge path and then discharged. Scanning of a face side of a subsequent original is stared immediately after completion of rear-side scanning of the preceding original.

### CROSS-REFERENCE TO RELATED APPLICATION

This application is based upon and claims the benefit of priority from provisional U.S. Application 60/972,478, filed on Sep. 14, 2007, the entire contents of which are incorporated herein by reference.

### TECHNICAL FIELD

The present invention relates to an automatic scanning apparatus that is used for a printer or the like to sequentially and automatically scan an original, and particularly to scan both sides of an original.

### BACKGROUND

Conventionally, as an image scanning apparatus that scans images on both sides of an original, for example, U.S. Pat. No. 6,434,359 or U.S. Pat. No. 6,522,860 proposes a technique of reversing a sheet supplied from a sheet supplying unit before scanning, then guiding the sheet to a scanning unit, scanning its one side, then reversing the sheet, and carrying the sheet again to the scanning unit.

However, in the conventional technique, a roller for carrying an already reversed first sheet for scanning and a roller for reversing a second sheet before scanning are rotated by the same extra roller. Therefore, when the first sheet and the second sheet pass by each other, at least the carrying of one of the sheets must be canceled. Therefore, the conventional technique requires a cancellation mechanism to cancel the carrying of the sheet and has a risk of complicating the sheet carrying operation. Moreover, when the two sheets pass by each other, the carrying of one of the sheets must be canceled. Therefore, the sheet cannot be continuously carried from a paper feeding unit to a discharge unit. That is, waiting occurs while the carrying of the sheet is canceled, generating a risk of obstructing high-speed image scanning.

Thus, for an automatic scanning apparatus capable of scanning both sides of an original, it is desired that an automatic scanning apparatus is developed in which the original carrying operation is simplified, thereby achieving a higher original carrying speed and hence a higher image scanning speed.

### SUMMARY

According to an aspect of the invention, simplification of the mechanism and hence simplification of the carrying operation allow continuous carrying of an original and thus enable high-speed scanning of both sides of the original.

According to an embodiment of the invention, an automatic scanning apparatus includes: a scanning unit configured to scan a traveling original; a first branch unit configured to allocate the original scanned by the scanning unit into a first direction or a second direction; a first carrying unit configured to move a first side of the original supplied from a paper feeding unit, in the scanning unit; a second carrying unit configured to reverse the original allocated into the first direction by the first branch unit and move a second side of the original in the scanning unit; and an idling reversing unit having a first paper discharge path which the original allocated into the second direction is discharged in the same direction as when the original is allocated, and a second paper discharge path which the original allocated into the second direction is reversed and discharged.

### DESCRIPTION OF THE DRAWINGS

FIG. 1 shows the schematic configuration of an image forming apparatus equipped with an automatic scanning apparatus according to an embodiment of the invention;

FIG. 2 shows the schematic configuration of a part of the automatic scanning apparatus according to the embodiment of the invention;

FIG. 3 is a block diagram showing a control system mainly concerned with an ADF according to the embodiment of the invention;

FIG. 4 is a flowchart showing operations from start of carrying an original to arrival of the first original at a pre-scanning stop position, in the ADF according to the embodiment of the invention;

FIG. 5 is a flowchart showing operations from standby for scanning of a first original to start of reverse paper feeding by a reverse registration roller, in the ADF according to the embodiment of the invention;

FIG. 6 is a flowchart showing operations from start of reverse paper feeding to scanning of the back side of the first original, in the ADF according to the embodiment of the invention;

FIG. 7 is a flowchart showing operations from back side reading to paper discharge, in the ADF according to the embodiment of the invention;

FIG. 8 is a schematic explanatory view showing the start of carrying of the original in the ADF according to the embodiment of the invention;

FIG. 9 is a schematic explanatory view showing alignment of the first original in the ADF according to the embodiment of the invention;

FIG. 10 is a schematic explanatory view showing the state where the first original is stopped before scanning in the ADF according to the embodiment of the invention;

FIG. 11 is a schematic explanatory view showing the state at the start of scanning the face side of the first original in the ADF according to the embodiment of the invention;

FIG. 12 is a schematic explanatory view showing the state at the end of scanning the face side of the first original in the ADF according to the embodiment of the invention;

FIG. 13 is a schematic explanatory view showing the state where the first original is carried to a reverse path in the ADF according to the embodiment of the invention;

FIG. 14 is a schematic explanatory view showing the state at the start of reverse carrying of the first original by a reverse registration roller in the ADF according to the embodiment of the invention;

FIG. 15 is a schematic explanatory view showing the state of standby for scanning the back side of the first original in the ADF according to the embodiment of the invention;

FIG. 16 is a schematic explanatory view showing the state at the start of scanning the back side of the first original in the ADF according to the embodiment of the invention;

FIG. 17 is a schematic explanatory view showing the state where the first original is turned into a branch by a second guide in the ADF according to the embodiment of the invention;

FIG. 18 is a schematic explanatory view showing the state at the end of scanning the back side of the first original in the ADF according to the embodiment of the invention;

FIG. 19 is a schematic explanatory view showing the state where the first original is turned to a paper discharge path and the face side of the next original is being scanned in the ADF according to the embodiment of the invention;

FIG. 20 is a schematic explanatory view showing the state where the first original is being reversed and discharged and the next original is being carried out through the reverse path in the ADF according to the embodiment of the invention;

FIG. 21 is a schematic explanatory view showing the state where the first original is discharged in the ADF according to the embodiment of the invention;

FIG. 22 is a schematic explanatory view showing the state at the start of scanning the back side of the next original in the ADF according to the embodiment of the invention;

FIG. 23 is a schematic explanatory view showing the state at the end of scanning the back side of the next original in the ADF according to the embodiment of the invention;

FIG. 24 is a schematic explanatory view showing the state of reverse discharge of the next original in the ADF according to the embodiment of the invention;

FIG. 25 is a schematic explanatory view showing the state where the next original is discharged in the ADF according to the embodiment of the invention; and

FIG. 26 is a schematic explanatory view showing a single-side carrying original path in the ADF according to the embodiment of the invention.

### DETAILED DESCRIPTION

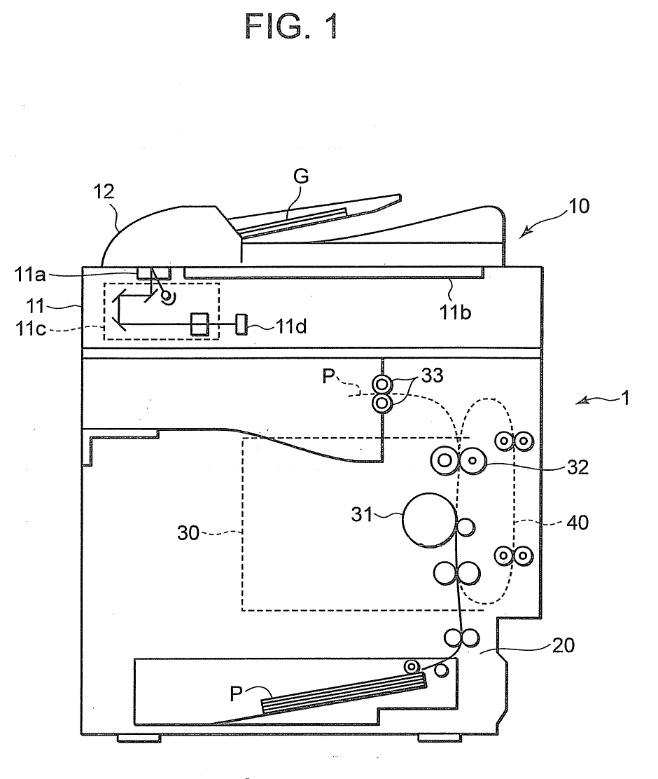

Hereinafter, an embodiment of the invention will be described in detail with reference to the attached drawings. FIG. 1 shows the schematic configuration of an image forming apparatus 1 equipped with an automatic scanning apparatus 10 according to the embodiment of the invention. The automatic scanning apparatus 10 on top of the image forming apparatus 1 has a scanner 11 as a scanning unit, and an automatic document feeder (ADF) 12 that carries an original to the scanner 11. The scanner 11 has a READ original glass 11a, an original glass 11b, an optical mechanism 11c that optically scans an original G set on the original glass 11b or traveling on the READ original glass 11a, and an image sensor lid that photoelectrically converts an optical signal from the optical mechanism 11c to an electric signal.

The image forming apparatus 1 has a paper feeding unit 20 that supplies a paper sheet P, an image forming unit 30 that forms a toner image on a photoconductive drum 31 and transfers the toner image onto the supplied paper sheet P to form an image thereon, a fixing unit 32 that fixes the image on the paper sheet P, paper discharge rollers 33 that carries the sheet paper P to the paper discharge side, and a re-carrying unit 40 that supplies the paper sheet P again to the image forming unit 30 in double-side copying. The structure of the image forming apparatus 1 is not limited to this. Any arbitrary structure may be employed such as a color image forming apparatus having plural photoconductive drums.

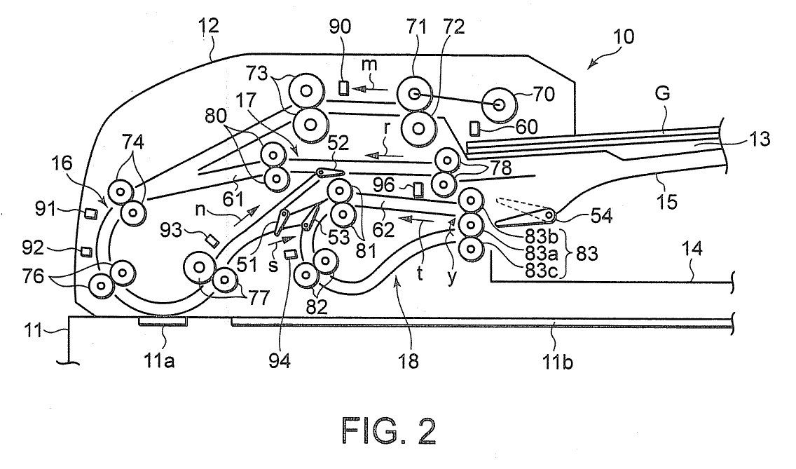

The automatic scanning apparatus 10 will now be described in detail. As shown in FIG. 2, an automatic document feeder (ADF) 12 of the automatic scanning apparatus 10 is a paper feeding unit. The ADF 12 has an original tray 13 on which an original G is set, and a paper discharge tray 14 as a paper discharge unit that collects the original G discharged after the end of scanning. A reverse paper path 15 that supports the original G when reversing the original G is formed below the original tray 13. The ADF 12 also has a paper feeding path 16 as a first carrying unit, a reverse path 17 as a second carrying unit, and a paper discharge path 18 as an idling reversing unit.

The ADF 12 has a first gate 51 as a first branch unit. The first gate 51 allocates the original G into the direction of the reverse path 17, which is a first direction, and the direction of the paper discharge path 18, which is a second direction. The first gate 51 is operated by a first gate switching solenoid 56. The ADF 12 also has a second gate 52 that guides, in the reverse path 17, the reversed original G into the direction of the READ original glass 11a, and a third gate 53 that guides, in the paper discharge path 18, the reversed original G into the direction of the paper discharge tray 14, which is the paper discharge direction. The second gate 52 operates by its own weight. The third gate 53 constantly receives a counterclockwise rotational force in FIG. 2 caused by, for example, an elastic force of a coil. The ADF 12 has a fourth gate 54 as a second branch unit. The fourth gate 54 allocates the original carried by a first driven roller 83b as a first paper discharge roller in the paper discharge path 18, into the direction of the reverse paper path 15 and into the direction of the paper discharge tray 14, which is the paper discharge direction. The fourth gate 54 is operated by a fourth gate switching solenoid 57.

An empty sensor (SR1) 60 that detects the presence or absence of the original G is provided above the original tray 13. The paper feeding path 16 has a pickup roller 70 that takes out the original G from the original tray 13, a paper feeding roller 71 and a separation roller 72 that prevent take-out of two sheets of the original G, registration rollers 73 that align the forward end of the original G, intermediate carrying rollers 74 that transmit the carrying of the original G, and pre-read rollers 76. The reverse path 17 has post-read rollers 77, reverse rollers 78 as reverse supply rollers, and reverse registration rollers 80.

In the path from the reverse rollers 78 to the reverse registration rollers 80 and then to the intermediate carrying rollers 74, a first guide 61 as a reverse guide is provided. The paper discharge path 18 has paper discharge intermediate rollers 81, paper discharge reverse rollers 82, and triple paper discharge rollers 83 including a main roller 83a, a first driven roller 83b and a second driven roller 83c. The first driven roller 83b is a first paper discharge roller. The second driven roller 83c is a second paper discharge roller. The main roller 83a forms a nip together with the first driven roller 83b. The main roller 83a also forms a nip together with the second driven roller 83c. In the path from the first driven roller 83b to the paper discharge intermediate rollers 81 and the paper discharge reverse rollers 82 and then to the second driven roller 83c, a U-shaped second guide 62 as an idling reverse guide is provided.

The second guide 62 has a first carrying path which the original allocated into the paper discharge path 18 is discharged from the paper discharge intermediate rollers 81 into the direction of the nip between the first driven roller 83b and the main roller 83a. The second guide 62 also has a second carrying path which the original allocated into the paper discharge path 18 is discharged from the nip between the first driven roller 83b and the main roller 83a, the paper discharge intermediate rollers 81 and the paper discharge reverse rollers 82 and then from the nip between the second driven roller 83c and the main roller 83a.

The pickup roller 70, the paper feeding roller 71 and the separation roller 72 are driven by a paper feeding motor 86 that rotates forward. The registration rollers 73 are driven by the paper feeding motor 86 that rotates backward. The pickup roller 70 is fluctuated by a pickup solenoid 70a. The reverse rollers 78 are driven by a switchback motor 84 that rotates forward and backward, as a second driving source. The intermediate carrying rollers 74, the pre-read rollers 76, the post-read rollers 77, and the reverse registration rollers 80 are driven by a read motor 87.

The paper discharge intermediate rollers 81, the paper discharge reverse rollers 82, and the main roller 83a are driven by a paper discharge motor 88 that rotates forward and backward, as a first driving source. When the paper discharge motor 88 rotates forward, the main roller 83a rotates in the direction of an arrow y and rotates the first driven roller 83b and the second driven roller 83c backward in the same timing. When the paper discharge motor 88 rotates forward, the first driven roller 83b carries the original in the opposite direction of an arrow t as passing direction through the nip with the main roller 83a. When the paper discharge motor 88 rotates backward, the first driven roller 83b carries the original in the direction of an arrow t as reverse direction through the nip with the main roller 83a. When the paper discharge motor 88 rotates backward, the second driven roller 83c carries the original in the paper discharge direction through the nip with the main roller 83a.

A registration sensor 90, an intermediate sensor 91 and a pre-read sensor 92 are arranged on the paper feeding path 16. The registration sensor 90 detects arrival of the original G at the registration rollers 73. The intermediate sensor 91 and the pre-read sensor 92 are used for the driving timing of the paper feeding motor 86 and the read motor 87.

On the reverse path 17, a post-read sensor 93 is provided which is used for the driving timing of the read motor 87 and the switchback motor 84. On the paper discharge path 18, a paper discharge reverse sensor 94 used for the driving timing of the paper discharge motor 88, and a paper discharge sensor 96 are provided.

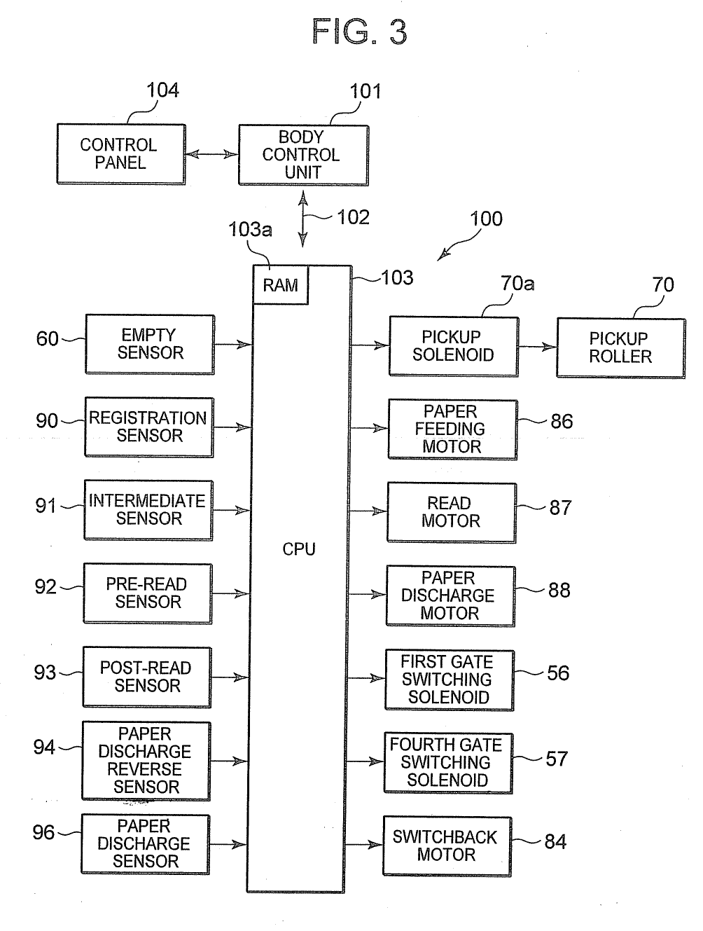

FIG. 3 shows a block diagram of a control system 100 mainly concerned with the ADF 12. A control panel 104 of the image forming apparatus 1 is connected to a body control unit 101 that controls the entire image forming apparatus 1. The body control unit 101 controls a CPU 103 of the automatic scanning apparatus 10 via an input and output interface 102. The empty sensor 60, the registration sensor 90, the intermediate sensor 91, the pre-read sensor 92, the post-read sensor 93, the paper discharge reverse sensor 94, and the paper discharge sensor 96 are connected to the input side of the CPU 103 having a RAM 103a. The pickup solenoid 70a that fluctuates the pickup roller 70, the switchback motor 84, the paper feeding motor 86, the read motor 87, the paper discharge motor 88, the first gate switching solenoid 56 and the fourth gate switching solenoid 57 are connected to the output side of the CPU 103.

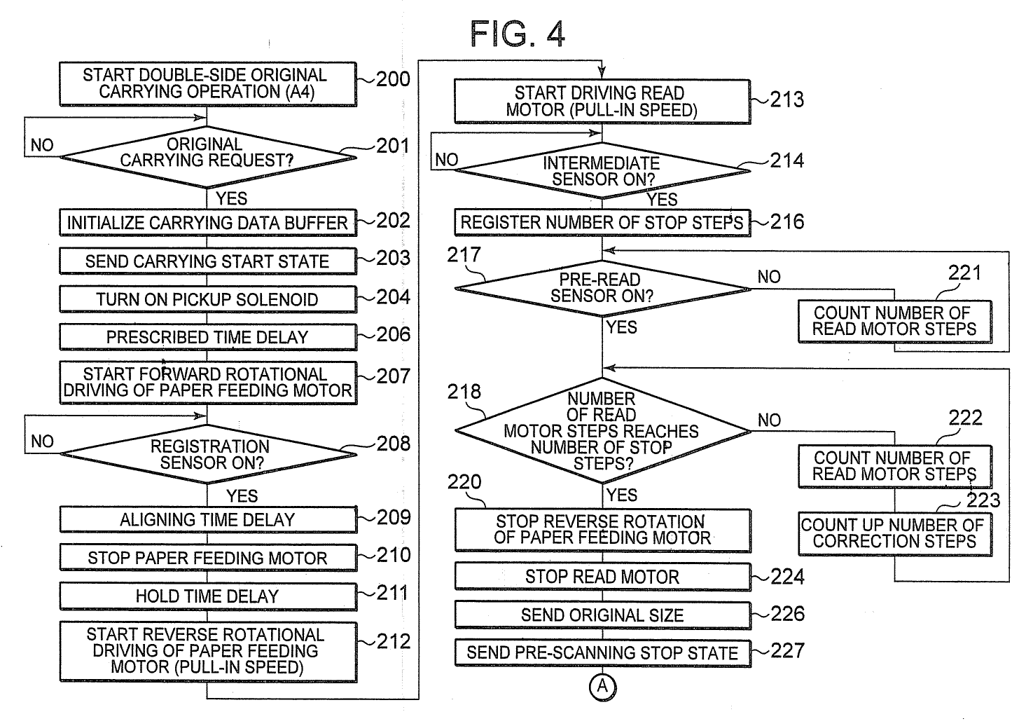

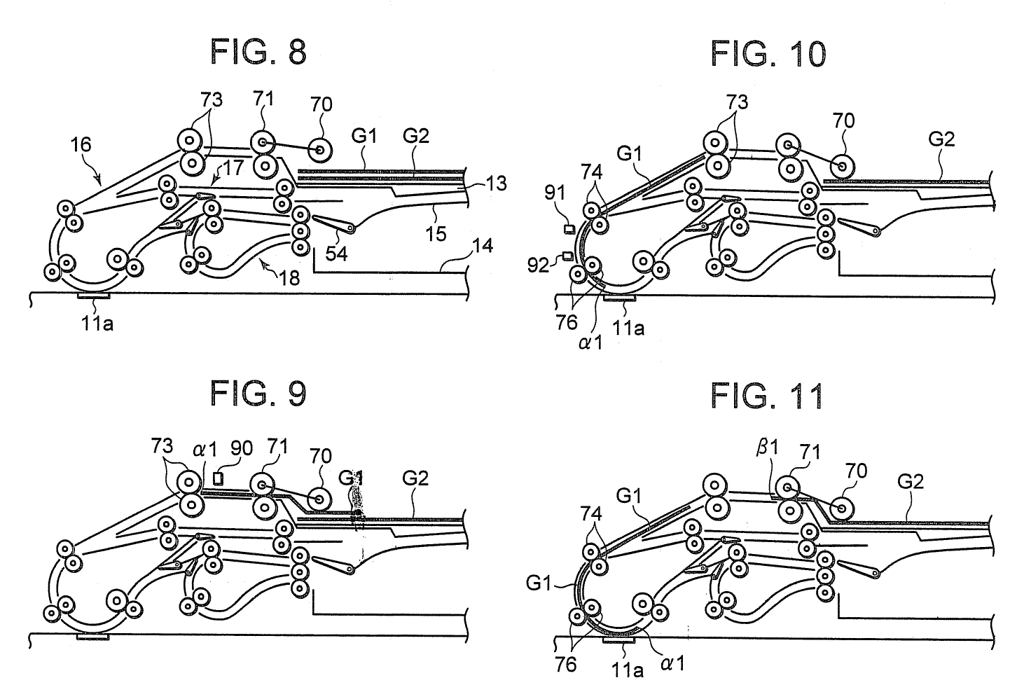

Next, double-side carrying by the ADF 12 will be described with reference to the flowcharts of FIG. 4 to FIG. 7, in which both the face side of the original as a first side and the back side as a second side are moved on the READ original glass 11a of the scanner 11. For example, carrying of the original G having A4 size (210 mm×297 mm) of the JIS standards (Japanese Industrial Standards) is started. As shown in FIG. 8, two originals G1 and G2 are set on the original tray 13. The empty sensor 60 turns on and sends an original set-on signal to the body control unit 101. The operator sets various image forming conditions and the double-side carrying of the original G by the ADF 12, on the control panel 104, and starts the operation to carry the original G (Act 200).

When an original carrying request is issued from the body control unit 101 (Yes in Act 201), the CPU 103 initializes a carrying data buffer of the RAM 103a (Act 202) and sends a carrying start state to the body control unit 101 (Act 203). The CPU 103 turns on the pickup solenoid 70a (Act 204). After a prescribed time delay (Act 206), forward rotational driving of the paper feeding motor 86 is started to rotate the pickup roller 70, the paper feeding roller 71 and the separation roller 72 (Act 207) and paper supply for reading the face side of the first original G1 is started. The original G1 is carried in the direction of an arrow m in FIG. 2. As the registration sensor 90 turns on (Yes in Act 208) and the time to reach alignment is delayed (Act 209), the paper feeding motor 86 stops (Act 210). As shown in FIG. 9, the forward end α1 of the original G1 contacts the registration rollers 73 and its alignment is completed.

After the time until the forward end α1 of the original G1 holds is delayed (Act 211), the paper feeding motor 86 is rotated backward to rotate the registration rollers 73 at a high speed (pull-in speed) and pulling-in of the original G1 is started (Act 212). The read motor 87 is driven and the original G1 is carried at a high speed (pull-in speed) by the intermediate carrying rollers 74 and the pre-read rollers 76 (Act 213).

When the intermediate sensor 91 turns on (Yes in Act 214), the number of stop steps until the read motor 87 stops is registered to the RAM 103a (Act 216). As the pre-read sensor 92 turns on (Yes in Act 217) and the number of steps of the read motor 87 reaches the number of stop steps (Yes in Act 218), the reverse rotational driving of the paper feeding motor 86 is stopped (Act 220). During this time, the number of driving steps of the read motor 87 is counted in Act 221 or Act 222. In Act 223, the number of correction steps is counted up. The driving of the read motor 87 is stopped (Act 224). The original size of the original G detected by the registration sensor 90 is sent to the body control unit 101 (Act 226). A pre-scanning stop state is sent to the body control unit 101 (Act 227). As shown in FIG. 10, the forward end α1 of the original G1 reaches the pre-scanning stop position.

When a DF scan command for moving the face side of the original G1 is received from the body control unit 101 (Yes in Act 231) and the empty sensor 60 detects a subsequent original (Yes in Act 232), feeding of the next original G2 is started (Act 233) and the next original G2 is supplied at the same time. However, the next original G2 stands by at a pull-in standby position until the back side of the first original G1 is scanned and the rear end α2 of the original G1 exits the intermediate sensor 91. The pull-in standby position is, for example, a position that is reached with a prescribed time delay after the forward end β1 of the next original G2 exits the registration rollers 73.

The CPU 103 calculates the number of steps until the start of scanning the face side of the original G1 (Act 234), from the number of correction steps counted in Act 223, and starts driving the read motor 87. The intermediate carrying rollers 74, the pre-read rollers 76 and the post-read rollers 77 carry the original G1 at a scanning speed (Act 236). Forward rotational driving of the switchback motor 84 is started and the reverse rollers 78 are rotated at the scanning speed (Act 237).

When the number of steps until the start of scanning, calculated in Act 234, is reached after the start of carrying the original G1 (Yes in Act 238), the body control unit 101 turns on an exposure start signal from the optical mechanism 11c (Act 240) and starts scanning the face side of the original G1. As shown in FIG. 11, the forward end α1 of the original G1 advances by a predetermined number of steps on the READ original glass 11a and the forward end β1 of the next original G2 reaches the position of the paper feeding roller 71 and the separation roller 72.

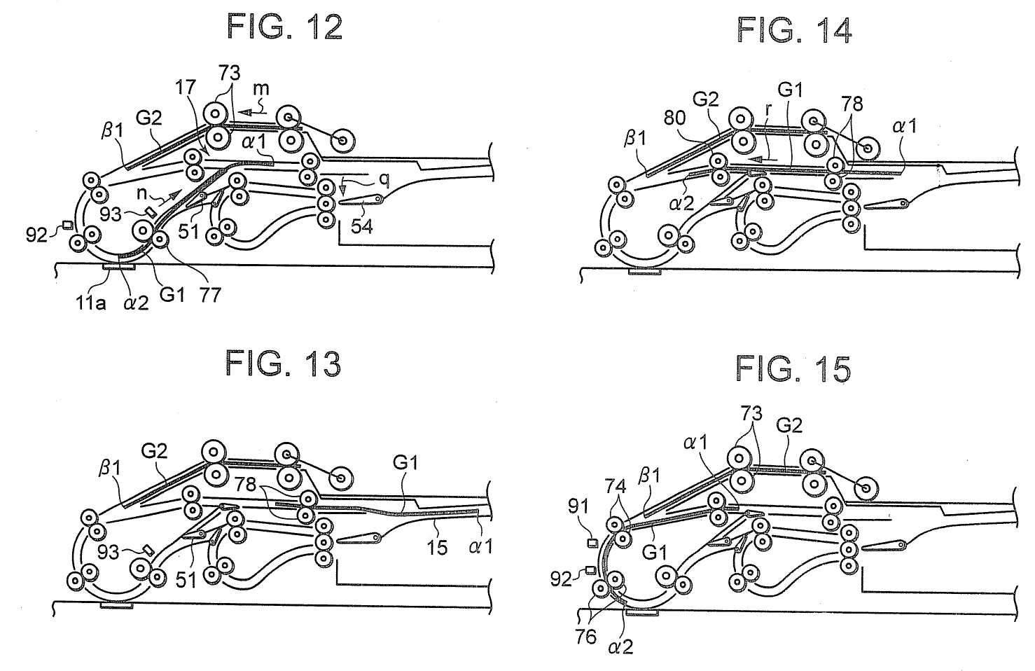

The first gate switching solenoid 56 is turned on (Act 241) to switch the first gate 51 into the direction of opening the reverse path 17. The original G1 is turned into the direction of an arrow n in FIG. 2 by the first gate 51. When the post-read sensor 93 turned on (Yes in Act 242), the fourth gate switching solenoid 57 is turned on to turn the fourth gate 54 into the direction of an arrow q, thus arranging the fourth gate 54 at the position shown in FIG. 12 (Act 243). As the fourth gate switching solenoid 57 is turned on, the original G carried in the opposite direction of the arrow t by the first driven roller 83b is turned into the direction of the reverse paper path 15.

With a prescribed time delay (Act 246) after the rear end of the original G1 passes and the pre-read sensor 92 turns off (Yes in Act 244), the body control unit 101 turns off the exposure start signal (Act 247) and finishes scanning the face side of the original G1. As shown in FIG. 12, the forward end α1 of the original G1 is guided into the direction of the reverse path 17, in which the direction of the arrow n. The forward end β1 of the next original G2 is at the pull-in standby position.

When the post-read sensor 93 turns off (Yes in Act 248), the read motor 87 is stopped and the intermediate carrying rollers 74, the pre-read rollers 76 and the post-read rollers 77 are thus stopped (Act 250). After a prescribed time delay (Act 251), the switchback motor 84 is stopped and the reverse rollers 78 are thus stopped (Act 252). The first gate switching solenoid 56 is turned off to switch the first gate 51 into the direction of opening the paper discharge path 18 (Act 253). As shown in FIG. 13, the forward end α1 side of the original G1 is supported in the reverse paper path 15 and the forward end β1 of the next original G2 stands by at the pull-in standby position.

After a hold time delay (Act 254), reverse rotational driving of the switchback motor 84 is started to rotate the reverse rollers 78 backward at a high speed (pull-in speed). Thus, pulling-in of the original G1 into the reverse registration rollers 80 direction, which is the direction of the arrow r in FIG. 2, is stared (Act 256). Then, forward rotational driving of the read motor 87 is started and the original G1 is carried at a high speed (pull-in speed) by the reverse registration rollers 80, the intermediate carrying rollers 74 and the pre-read rollers 76 (Act 257). As shown in FIG. 14, the rear end α2 of the original G1 is carried by the reverse registration rollers 80 and the forward end β1 of the next original G2 stands by at the pull-in standby position.

After a prescribed time delay (Act 260), the switchback motor 84 is stopped (Act 261). When the intermediate sensor 91 turns on (Yes in Act 264), the number of stop steps until the read motor 87 stops is registered to the RAM 103a (Act 266). As the pre-read sensor 92 turns on (Yes in Act 267) and the number of steps of the read motor 87 reaches the number of stop steps (Yes in Act 268), the driving of the read motor 87 is stopped (Act 274). During this time, the number of driving steps of the read motor 87 is counted in Act 271 or Act 272. Meanwhile, in Act 273, the number of correction steps is counted up. A pre-scanning stop state is sent to the body control unit 101 (Act 276). As shown in FIG. 15, the rear end α2 of the original G1 reaches the pre-scanning stop position and the forward end β1 of the next original G2 stands by at the pull-in standby position.

On receiving a DF scan command for moving the back side of the original G1 from the body control unit 101 (Yes in Act 278), the CPU 103 calculates the number of steps to the start of scanning of the back side of the original G1 (Act 280), from the number of correction steps counted in Act 273, and starts driving the read motor 87. The original G1 is carried at a scanning speed by the intermediate carrying rollers 74, the pre-read rollers 76 and the post-read rollers 77 (Act 281). Forward rotational driving of the paper discharge motor 88 is started to rotate at a scanning speed the paper discharge intermediate rollers 81, the paper discharge reverse rollers 82 and the paper discharge rollers 83 (Act 282).

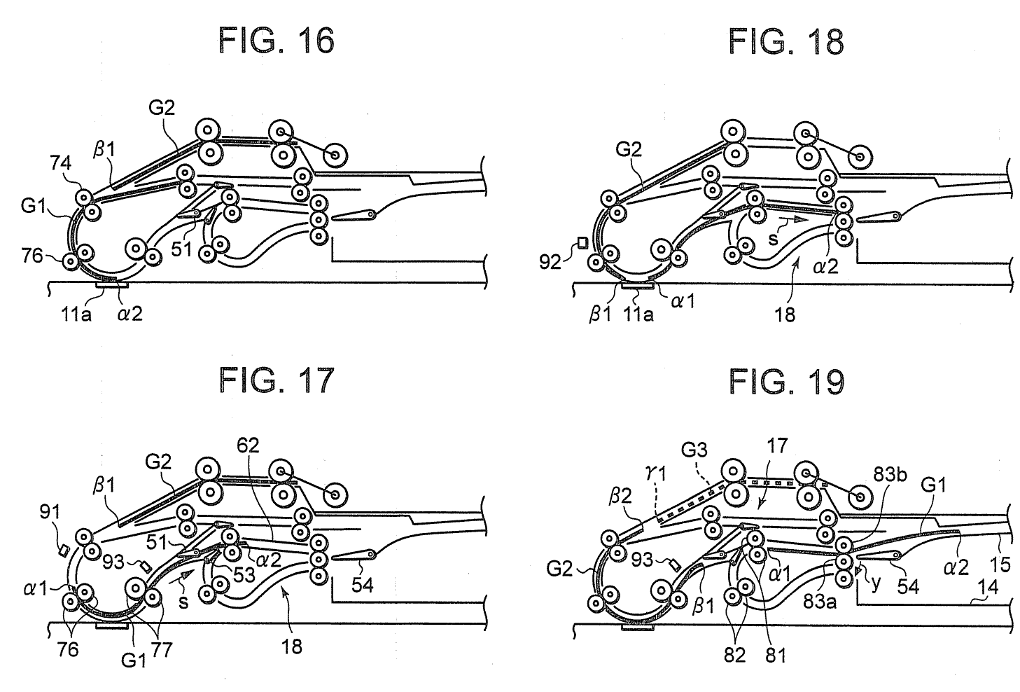

When the number of steps to the start of scanning calculated in Act 280 is reached after the start of reverse carrying of the original G1 (Yes in Act 283), the body control unit 101 turns on an exposure start signal from the optical mechanism 11c (Act 284) to start scanning the back side of the original G1. The first gate switching solenoid 56 maintains the off-state and the first gate 51 maintains the direction of opening the reverse path 17 (Act 286). As shown in FIG. 16, the rear end α2 advances by predetermined steps on the READ original glass 11a and the forward end β1 of the next original G2 stands by at the pull-in standby position.

When the rear end α2 of the original G1 reaches the post-read sensor 93 and the post-read sensor 93 turns on (Yes in Act 287), the fourth gate switching solenoid 57 maintains the on-state and the fourth gate 54 maintains the position shown in FIG. 12 (Act 288). The original G1 is turned into the direction of the arrow s in FIG. 2 by the first gate 51 and guided into the direction of the paper discharge path 18. The original G1 guided into the direction of the paper discharge path 18 passes above the third gate 53 and travels in the direction of the arrow s on the second guide 62, as shown in FIG. 17. When the forward end α1 of the original G1 ends its passage over the third gate 53, the third gate 53 closes the lateral side of the second guide 62 by receiving the counterclockwise rotational force caused by the elastic force of the coil.

When the forward end α1 of the original G1 exits the intermediate sensor 91 and the intermediate sensor 91 turns off (Yes in Act 290), a pull-in start operation of the next original G2 is started (Act 291). As the pull-in start operation of the next original G2 is started, the next original G2 returns to Act 212 and double-side scanning is carried out similarly to the case of the first original G1. The carrying of the next original G2 is done parallel to the carrying of the first original G1. However, after Act 291, the operation of the ADF 12 is adapted for reading the next original G2.

As the forward end α1 of the first original G1 exits the pre-read sensor 92 and the pre-read sensor 92 turns off (Yes in Act 292), and then after a prescribed time delay (Act 293), the body control unit 101 turns off the exposure start signal (Act 294). The scanning of the back side of the original G1 is thus finished. For the next original G2, Acts 212 to 227 in the flowchart of FIG. 4 are conducted. Both the paper feeding motor 86 and the read motor 87 are stopped. As shown in FIG. 18, the first original G1 travels in the direction of the arrow s in the paper discharge path 18. The forward end β1 of the next original G2 reaches the pre-scanning stop position.

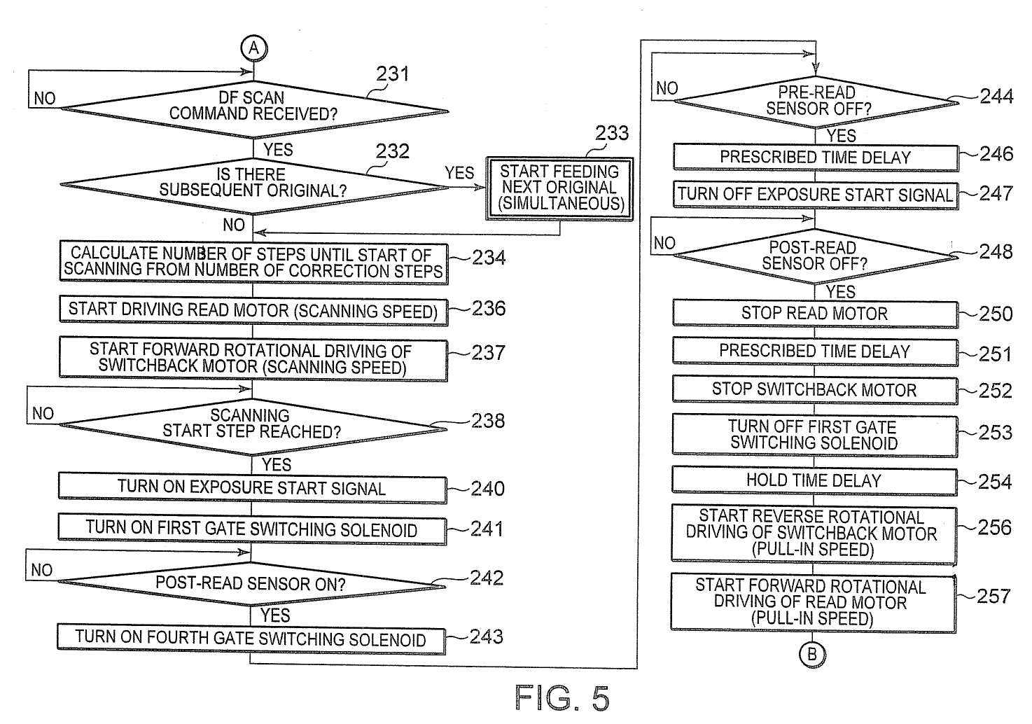

As the forward end α1 of the first original G1 passes and the post-read sensor 93 turns off (Yes in Act 296), and then after a prescribed time delay (Act 298), forward rotation of the paper discharge motor 88 is stopped (Act 300). Forward rotation of the paper discharge intermediate rollers 81, the paper discharge reverse rollers 82 and the paper discharge rollers 83 in the direction of the arrow y is stopped. For the next original G2, Acts 231, 232, 234 to 243 in the flowchart of FIG. 5 are conducted. If there is a subsequent original in Act 232, for example, paper feeding of a third original is started similarly to the start of paper feeding of the next original G2 in Act 233.

As shown in FIG. 19, the original G1 is nipped in the nip between the main roller 83a and the first driven roller 83b. The rear end α2 side of the original G1 is supported in the reverse paper path 15 and the forward end al of the original G1 is already out of the paper discharge intermediate rollers 81. The next original G2, after having its face side scanned, is turned into the direction of the reverse path 17. If there is a subsequent third original G3, the original G3 is supplied and its forward end γ1 stands by at the pull-in standby position, as indicated by a dotted line. At this time, the three originals G1, G2 and G3 are carried in the ADF 12.

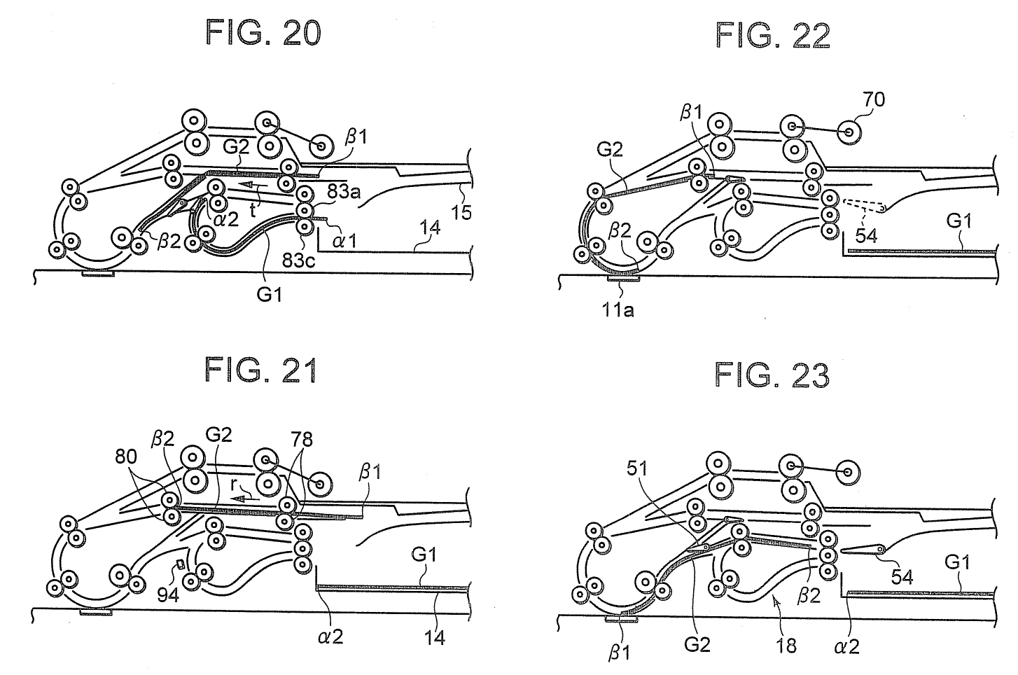

After a hold time delay (Act 302), reverse rotational driving of the paper discharge motor 88 is started at a discharge speed (Act 303). The paper discharge intermediate rollers 81, the paper discharge reverse rollers 82 and the paper discharge rollers 83 are rotated backward. The original G1 nipped in the nip between the main roller 83a and the first driven roller 83b is carried backward into the direction of an arrow t in the second guide 62. The original G1 is nipped between the paper discharge intermediate rollers 81, between the paper discharge reverse rollers 82, and in the nip between the main roller 83a and the second driven roller 83c, and thus carried into the direction of the paper discharge tray 14. As shown in FIG. 20, the original G1 is nipped in the nip between the main roller 83a and the second driven roller 83c and thus carried into the direction of the paper discharge tray 14. During this time, scanning of the face side of the next original G2 is finished and its forward end β1 is carried into the direction of the reverse paper path 15.

When the rear end α2 of the original G1 exits the paper discharge reverse sensor 94 and the paper discharge reverse sensor 94 turns off (Yes in Act 306), a prescribed time delay is given (Act 310) and then reverse rotation of the paper discharge motor 88 is stopped (Act 311). For the next original G2, Acts 244 to 256 in the flowchart of FIG. 5 are conducted. The next original G2 is carried backward in the direction of the arrow r by the reverse rollers 78 rotating backward at a high speed (pull-in speed) (Act 256). As shown in FIG. 21, the original G1 is discharged onto the paper discharge tray 14. The next original G2 is aligned as its rear end β2 contacts the reverse registration rollers 80.

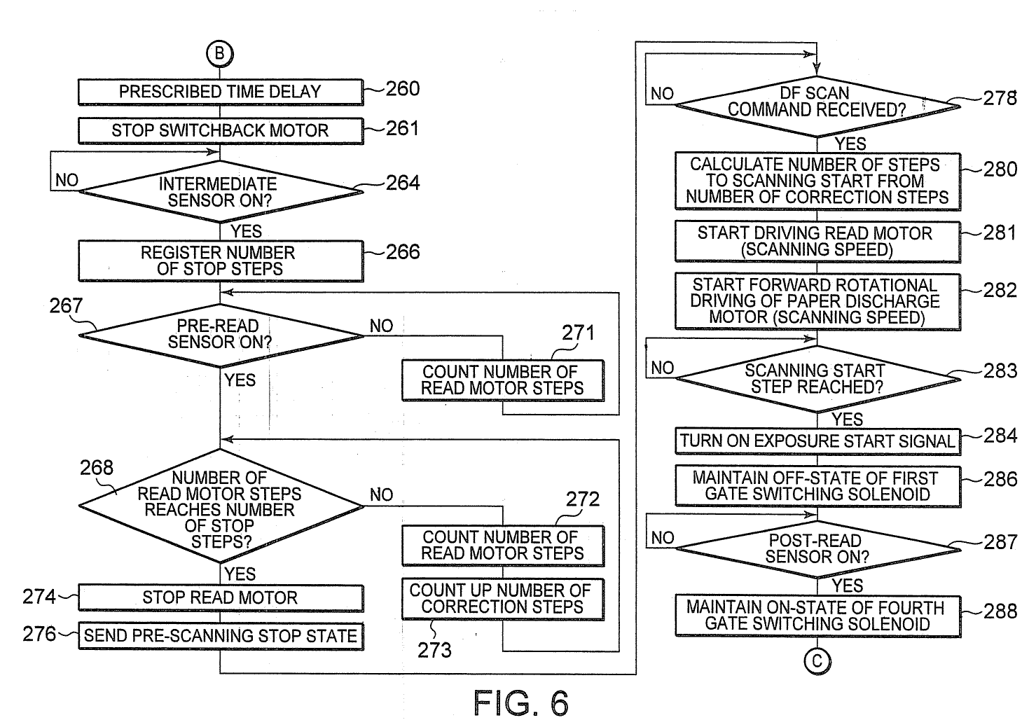

If there is no subsequent original (No in Act 312), the pickup solenoid 70a is turned off (Act 313) and the fourth gate switching solenoid 57 is turned off (Act 314). A carrying end state is sent to the body control unit 101 (Act 316) and all the carrying operations end. If there is a subsequent original (Yes in Act 312), double-side carrying of the first original G1 ends in this state. For the subsequent original, the operations following Act 257 are repeated similarly to the case of the first original G1. For the next original G2, Act 257 in the flowchart of FIG. 5 and Acts 260 to 284 in the flowchart of FIG. 6 are conducted. As shown in FIG. 22, scanning of the back side of the next original G2 is started.

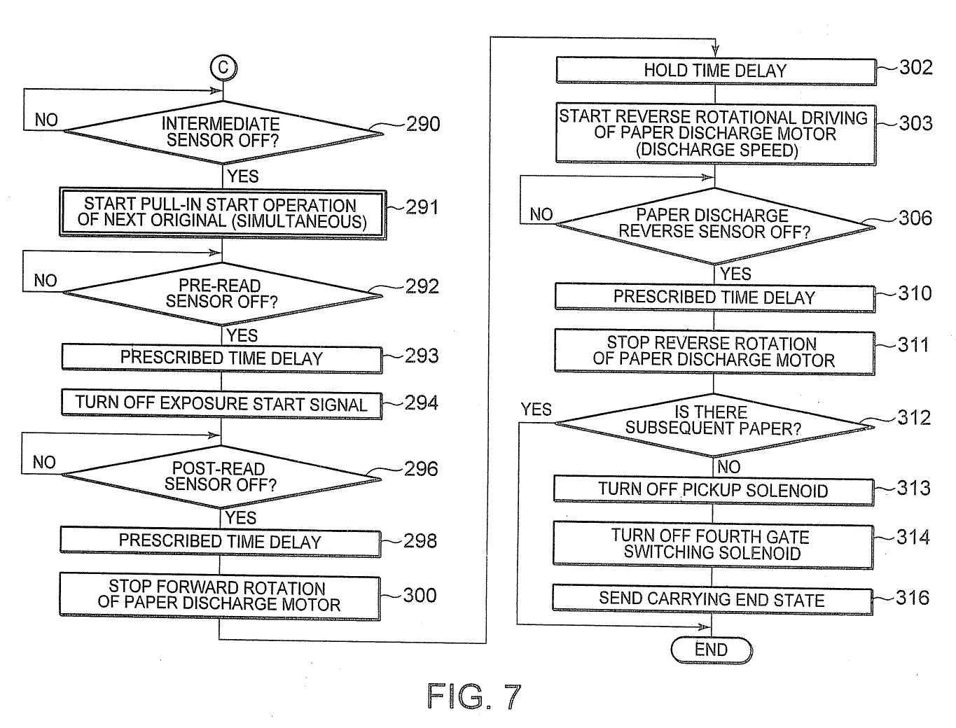

Then, Acts 287 and 288 in the flowchart of FIG. 6 and Acts 290 to 294 in the flowchart of FIG. 7 are conducted for the next original G2. As shown in FIG. 23, the next original G2 is turned into the direction of the paper discharge path 18 by the first gate 51 and scanning of its back side is completed.

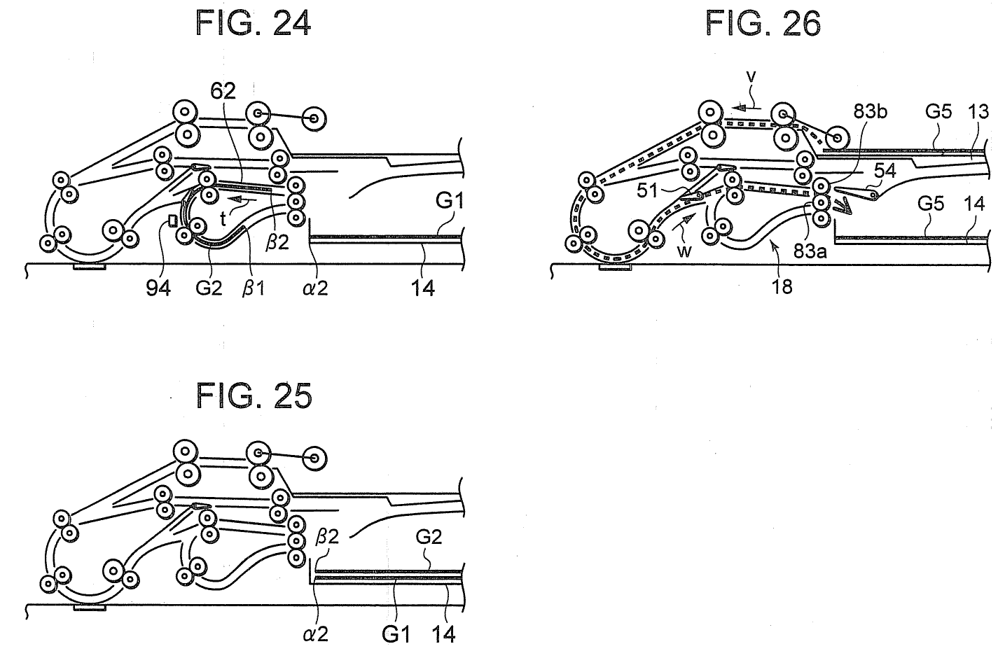

For the next original G2, Acts 294 to 303 in the flowchart of FIG. 7 are then conducted. As shown in FIG. 24, the next original G2 is carried backward into the direction of the arrow t in the second guide 62.

For the next original G2, Acts 306 to 311 in the flowchart of FIG. 7 are then conducted. As shown in FIG. 25, the next original G2 is discharged onto the first original G1 on the paper discharge tray 14. The body control unit 101 ends all the operations in the ADF 12.

When the ADF 12 performs single-side carrying, the paper feeding motor 86, the read motor 87 and the paper discharge motor 88 are driven in predetermined timing. The switchback motor 84 is not driven. The first gate switching solenoid 56 is turned off and the paper discharge path 18 is opened by the first gate 51. The fourth gate switching solenoid 57 is turned off and the fourth gate 54 guides the originals G in the direction of the paper discharge tray 14. During being carried an original G5 on the original tray 13 sequentially travels the path indicated by a dotted line in FIG. 26 and is thus carried into the direction of the paper discharge tray 14.

As carrying is started, the original G5 is taken out from the original tray 13 into the direction of an arrow v in predetermined timing. The original G5 pulled into the paper feeding path 16 is scanned on the READ original glass 11a and then turned into the direction of the paper discharge pass 18 indicated by an arrow w, by the first gate 51. The original G5 is nipped in the nip between the main roller 83a and the first driven roller 83b and discharged from the paper discharge path 18. The original G5 is then guided by the fourth gate 54 and discharged onto the paper discharge tray 14.

According to this embodiment, the paper discharge path 18 capable of reversing the originals G after completion of scanning, is provided separately from the reverse path 17 for double-side scanning of the originals G. The first original G1 on which double-side scanning is completed does not need to pass over the READ original glass 11a for reverse paper discharge. Consequently, after completion of double-side scanning, the original G1 is reversed in the paper discharge path 18 and discharge onto the paper discharge tray 14 in page order. Scanning of the face side of the next original G2 can be started immediately after completion of rear-side scanning of the first original G1. Moreover, since the reverse path 17 and the paper discharge path 18 are separate paths, the next original G2 can be carried without being influenced by the first original G1. That is, paper feeding, double-side scanning, and reverse paper discharge of the originals G can be continuously carried out and high-speed operations can be realized depending on the setting of the carrying speed.

The invention is not limited to the above embodiment and various changes and modifications can be made without departing from the scope of the invention. For example, the number of driving motors, their driving areas and so on can be arbitrarily set as long as the rollers can be driven without exerting influence of carrying of a preceding original onto a subsequent original. The shapes of the guides in the carrying unit and the idling reversing unit are not limited, either. The idling reversing guide is not limited to U-shape as long as it is capable of idling reverse of an original after double-side scanning.

What is claimed is:

1. An automatic scanning apparatus comprising:
a scanning unit configured to scan a traveling original;
a first branch unit configured to allocate the original scanned by the scanning unit into a first direction or a second direction;
a first carrying unit configured to move a first side of the original supplied from a paper feeding unit, in the scanning unit;
a second carrying unit configured to reverse the original allocated into the first direction by the first branch unit and move a second side of the original in the scanning unit; and
an idling reversing unit having a first paper discharge path which the original allocated into the second direction is discharged in the same direction as when the original is allocated, and a second paper discharge path which the original allocated into the second direction is reversed and discharged.

2. The apparatus according to claim 1, wherein the idling reversing unit discharges the original allocated into the second direction, from the second paper discharge path after scanning of the second side.

3. The apparatus according to claim 1, wherein the idling reversing unit discharges the original allocated into the second direction, from the first paper discharge path after scanning of the first side.

4. The apparatus according to claim 1, wherein the idling reversing unit has: a first paper discharge roller capable of carrying the original after passing the first branch unit into a passing direction and a reverse direction; a second paper discharge roller that carries the original carried in the reverse direction by the first paper discharge roller, into a paper discharge direction; and an idling reverse guide that guides the original from the first paper discharge roller to the second paper discharge roller.

5. The apparatus according to claim 4, wherein the first paper discharge roller and the second paper discharge roller are rotated in opposite directions in the same timing by using a first driving source.

6. The apparatus according to claim 4, wherein the idling reversing unit has a second branch unit configured to branch the original carried from the first paper discharge roller into the passing direction, into a reverse paper path direction and the paper discharge direction.

7. The apparatus according to claim 4, wherein the second carrying unit has a reverse roller capable of carrying the original after passing the first branch unit into a reverse direction, and a reverse guide that guides the original carried into the reverse direction by the reverse roller to the scanning unit.

8. The apparatus according to claim 1, wherein while a preceding original is passing the second carrying path of the idling reversing unit, the first carrying unit moves a first side of a subsequent original supplied from the paper feeding unit, in the scanning unit.

9. The apparatus according to claim 1, wherein while a preceding original is passing the second carrying path of the idling reversing unit, the second carrying unit reverses a subsequent original allocated into the first direction.

10. An automatic document feeder comprising:
a first carrying unit configured to move a first side of an original supplied from a paper feeding unit, in a scanning unit;
a first branch unit configured to allocate the original after passing the scanning unit into a first direction or a second direction;
a second carrying unit configured to reverse the original allocated into the first direction by the first branch unit and move a second side of the original in the scanning unit; and
an idling reversing unit having a first paper discharge path which the original allocated into the second direction is discharged in the same direction as when the original is allocated, and a second paper discharge path which the original allocated into the second direction is reversed and discharged.

11. The automatic document feeder according to claim 10, wherein the idling reversing unit discharges the original allocated into the second direction, from the second paper discharge path after scanning of the second side.

12. The automatic document feeder according to claim 10, wherein the idling reversing unit discharges the original allocated into the second direction, from the first paper discharge path after scanning of the first side.

13. The automatic document feeder according to claim 10, wherein the idling reversing unit has: a first paper discharge roller capable of carrying the original after passing the first branch unit into a passing direction and a reverse direction; a second paper discharge roller that carries the original carried in the reverse direction by the first paper discharge roller, into a paper discharge direction; and an idling reverse guide that guides the original from the first paper discharge roller to the second paper discharge roller.

14. The automatic document feeder according to claim 13, wherein the idling reversing unit has a second branch unit configured to branch the original carried from the first paper discharge roller into the passing direction, into a reverse paper path direction and the paper discharge direction, and the second carrying unit has a reverse roller capable of carrying the original after passing the first branch unit into a reverse direction, and a reverse guide that guides the original carried into the reverse direction by the reverse roller, to the scanning unit, and wherein the first paper discharge roller and the second paper discharge roller are rotated in opposite directions in the same timing by using a first driving source.

15. The automatic document feeder according to claim 10, wherein while a preceding original is passing the second carrying path of the idling reversing unit, the first carrying unit moves a first side of a subsequent original supplied from the paper feeding unit, in the scanning unit, and the second carrying unit reverses a subsequent original allocated into the first direction.

16. An automatic scanning method comprising:
moving a first side of an original supplied from a paper feeding unit, in a scanning unit;
allocating the original with its first side scanned by the scanning unit into a first direction or a second direction;
after scanning of the first side, reversing the original allocated into the first direction and moving a second side of the original in the scanning unit; and
discharging the original allocated into the second direction, from one of a first paper discharge path which the original is discharged in the same direction as when the original is allocated, and a second paper discharge path which the allocated original is reversed and discharged.

17. The method according to claim 16, wherein after scanning of the second side, the original allocated into the second direction is discharged from the second paper discharge path.

18. The method according to claim 16, wherein after scanning the first side, the original allocated into the second direction is discharged from the first paper discharge path.

19. The method according to claim 16, wherein while a preceding original is passing the second carrying path, a first side of a subsequent original supplied from the paper feeding unit is moved in the scanning unit.

20. The method according to claim 16, wherein while a preceding original is passing the second carrying path, after scanning the first side of the original, a subsequent original allocated into the first direction is reversed and a second side of the subsequent original is moved in the scanning unit.
